(19) United States
(12) Patent Application Publication
(10) Pub. No.: US 2014/0340817 A1
(43) Pub. Date: Nov. 20, 2014

(54) SUPER CAPACITOR

(71) Applicant: AMOTECH CO., LTD., Incheon (KR)

(72) Inventors: Hyoung Tak NOH, Seoul (KR); Jong Gwan KIM, Ansan-si (KR); Byeong Sun LEE, Seoul (KR); Won Gil CHOI, Gunpo-si (KR)

(73) Assignee: AMOTECH CO., LTD., Incheon (KR)

(21) Appl. No.: 14/259,630

(22) Filed: Apr. 23, 2014

(30) Foreign Application Priority Data
May 20, 2013 (KR) 10-2013-0056560
Apr. 14, 2014 (KR) 10-2014-0043987

(51) Int. Cl. H01G 11/14; H01G 11/82

(52) U.S. Cl. CPC H01G 11/14; H01G 11/82
USPC 361/502

(57) ABSTRACT

Provided is a supercapacitor including: a power storage aggregate in which a plurality of unit modules are laminated; a case in which the power storage aggregate is disposed; an upper plate that is sealably mounted on an upper surface of the case; a lower plate that is sealably mounted on a lower surface of the case; and reinforcing plates that are disposed in the inner surfaces of the upper plate and the lower plate thereby reinforcing strength of the upper and lower plates, to thereby provide an effect of preventing the upper plate and the lower plate from being bent due to a rolling force of a power storage aggregate that is laminated in the case, and block an electrolyte from leaking.

### TECHNICAL FIELD

The present invention relates to supercapacitors in which a plurality of unit modules are laminated to form a power storage aggregate, and more particularly to supercapacitors which can uniformly maintain thickness between unit modules and which can prevent a warp of an upper plate and a lower plate.

### BACKGROUND ART

In general, supercapacitors use electrostatic characteristics but batteries use electrochemical reaction. Accordingly, the number of times for charging and discharging supercapacitors is almost infinite when compared to that of batteries, to thereby enable the supercapacitors to be used semi-permanently. In addition, supercapacitors have a very fast energy charging and discharging speed, respectively, to thereby show a power density that is several tens of times larger than that of each battery.

Therefore, applications of supercapacitors are now being gradually expanded over industrial fields due to the supercapacitor's features that cannot be obtained by conventional batteries.

In particular, effectiveness of supercapacitors as energy buffers is gradually increasing in the field of developing next-generation environmentally friendly vehicles such as Electric Vehicles (EV), Hybrid Electric Vehicles (HEV) or Fuel Cell Vehicles (FCV).

That is, supercapacitors are being used in combination with batteries as an auxiliary energy storage device, in which the supercapacitors take charge of an instantaneous energy supply and absorption, and the batteries take charge of an average vehicle energy supply, to thus expect to obtain effects of improving efficiency of an overall vehicle system and extending lifespan of an energy storage system.

In addition, supercapacitors can be used as secondary power supply devices in portable electronic products such as mobile phones and video recorders, and their importance and usage are gradually increasing.

The supercapacitors are largely classified into Electric Double Layer Capacitors (hereinafter referred to as EDLC capacitors) and hybrid supercapacitors using an electrochemical oxidation and reduction reaction.

While the EDLC capacitor accumulates charges by an electric double layer created on the surface of the EDLC capacitor, the hybrid supercapacitor accumulates charges by an electrochemical oxidation and reduction reaction together with an electric double layer created on the surface of an electrode material, to thereby provide an advantage of accumulating more energy relatively.

As disclosed in Korean Patent Laid-open Publication No. 10-2013-0016610 published on Feb. 18, 2013, a conventional capacitor power storage module includes: a power storage aggregate in which a number of unit supercapacitors and a power collector are alternately laminated; a pair of end plates that are arranged in the outermost position of the power storage aggregate to fix the power storage aggregate; a connecting beam that is fixed to one of the pair of the end plates and passes through the power storage aggregate and the pair of the end plates; and a bolt that fixes the connecting beam having passed through the power storage aggregate that has passed through the end plate to which the connecting beam has been fixed among the pair of the end plates and reaches the rest of the corresponding end plate, in which a separator is disposed between a positive (+) electrode and a negative (−) electrode, and a pair of gaskets for preventing the leakage of an electrolyte and an electrical short circuit, are formed in a lateral surface perpendicular to the separator.

However, since a pressure that is applied to a unit power storage module which is located at the lower side differs from a pressure that is applied to a unit power storage module which is located at the upper side when a plurality of unit power storage modules are laminated between the pair of the end plates, to thus cause a variation in thickness according to a lamination position of the unit power storage modules, the conventional power storage module suffers from a performance degradation problem.

Moreover, the conventional power storage module has a problem that a warp occurs when a reduction ratio is increased since a pair of end plates are formed in a flat plate shape.

Moreover, since a pair of end plates are formed in a flat plate shape, the conventional power storage module has a problem that an electrolyte leaks between the end plates and an outer wall.

### DISCLOSURE

### Technical Problem

To solve the above problems or defects, it is an object of the present invention to provide a supercapacitor in which a variation in thickness according to a lamination position of unit modules due to a rolling force can be reduced and a variation in alignment between the unit modules can be reduced, when the unit modules are laminated by mounting reinforcing members between the unit modules to laminate.

It is another object of the present invention to provide a supercapacitor in which structures of an upper plate and a lower plate are improved to prevent a phenomenon of a warp due to a rolling force of a power storage aggregate that is laminated in the inside of a case and prevent an electrolytic from leaking.

It is still another object of the present invention to provide a supercapacitor in which reinforcing plates are provided in inner surfaces of an upper plate and a bottom plate to reinforce the strength.

The objects of solving the technical problems of the present invention are not limited to the objects of solving the above-mentioned problems, and it will be clearly understood from the following description by one of ordinary skill in the art that there will be other objects of the present invention.

### Technical Solution

To accomplish the above and other objects of the present invention, according to an aspect of the present invention, there is provided a supercapacitor comprising: a power storage aggregate in which a plurality of unit modules are laminated; a case in which the power storage aggregate is disposed; an upper plate that is sealably mounted on an upper surface of the case; a lower plate that is sealably mounted on a lower surface of the case; and reinforcing plates that are disposed in the inner surfaces of the upper plate and the lower plate thereby reinforcing strength of the upper and lower plates.

Preferably but not necessarily, each of the upper plate and the lower plate comprises: a cover portion that is covered on the respective top and bottom surfaces of the case; and a projection portion that is integrally formed on the cover portion and inserted into the inner surface of the case.

Preferably but not necessarily, a plurality of first fastening holes are formed in the circumferential direction of the case, a plurality of second fastening holes are formed in the circumferential direction of the upper plate, a plurality of third fastening holes are formed in the circumferential direction of the lower plate, and corresponding holes of the first, second and third fastening holes are fastened by a single bolt.

Preferably but not necessarily, each unit module comprises: a current collector; a first active material layer that is laminated on one surface of the current collector; a second active material layer that is laminated on the other surface of the current collector; a first separator that is laminated on one surface of the first active material layer; and a second separator that is laminated on one surface of the second active material layer.

Preferably but not necessarily, the plurality of the unit modules are laminated to form the power storage aggregate, and reinforcing members are mounted between the current collectors of the unit modules.

Preferably but not necessarily, the reinforcing members are formed into a ring shape in which the outer surface of each of the reinforcing members contacts the inner wall surface of the case, and the upper and lower surfaces of each of the reinforcing members are supported by the current collectors.

### Advantageous Effects

As described above, a supercapacitor according to the present invention can reduce a variation in thickness according to a lamination position of unit modules due to a rolling force and a variation in alignment between the unit modules, when the unit modules are laminated by mounting reinforcing members between the unit modules.

In addition, a supercapacitor according to the present invention includes an upper plate and a lower plate on the lower surfaces of which projection portions that are inserted into the inside of a case are formed, and reinforcing plates that are disposed in the inner surfaces of the upper plate and the lower plate, to thus prevent a phenomenon of a warp due to a rolling force of a power storage aggregate that is laminated in the inside of the case and prevent an electrolytic from leaking.

Further, a supercapacitor according to the present invention includes unit modules that are laminated in a case to thus prevent an electrolytic from leaking laterally, and to reinforce the strength.

### DESCRIPTION OF DRAWINGS

FIG. 1 is an exploded perspective view of a supercapacitor in accordance with an embodiment of the invention.

FIG. 2 is a cross-sectional view of a supercapacitor according to one embodiment of the present invention.

FIG. 3 is a cross-sectional view of a power storage aggregate in which unit modules are stacked according to an embodiment of the present invention.

FIG. 4 is a perspective view for explaining a supercapacitor having outwardly projecting electrode plates according to one embodiment of the present invention.

FIG. 5 is an exploded side view of a supercapacitor having outwardly projecting electrode plates according to one embodiment of the present invention.

FIG. 6 is a perspective view for explaining the shape of the electrode plates of FIG. 5.

### BEST MODE

Hereinafter, embodiments of the present invention will be described in detail with reference to the accompanying drawings. In this process, the size and shape of the components illustrated in the drawings may be exaggerated for convenience and clarity of explanation. Further, by considering the configuration and operation of the present invention, the specifically defined terms can be changed according to a user or operator's intention or the custom. Definitions of these terms herein need to be made based on the content over the whole specification.

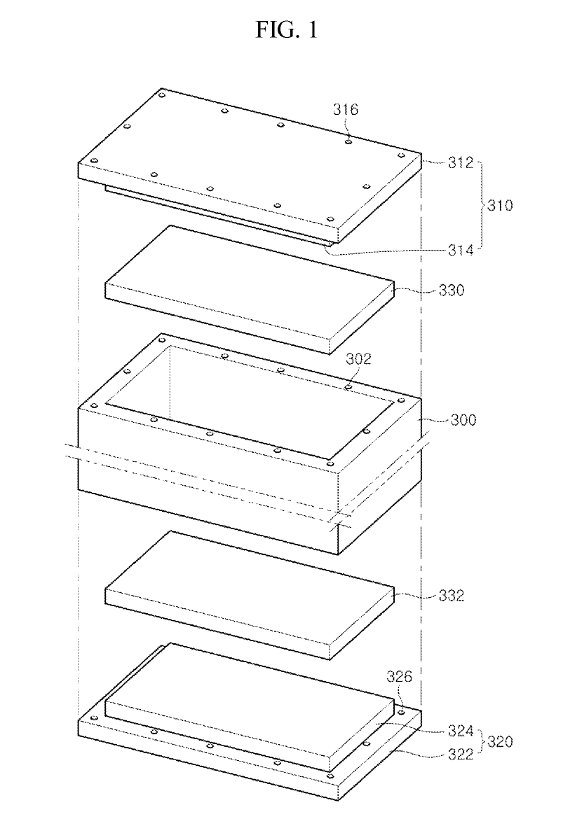

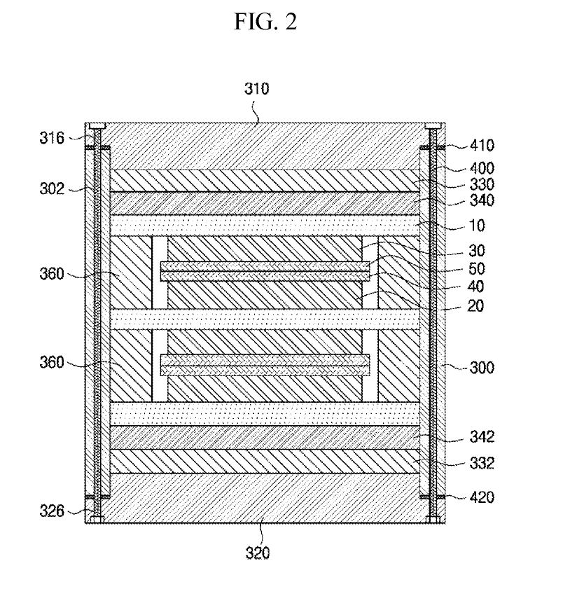

FIG. 1 is an exploded perspective view of a supercapacitor in accordance with an embodiment of the invention. FIG. 2 is a cross-sectional view of a supercapacitor according to one embodiment of the present invention. FIG. 3 is a cross-sectional view of a power storage aggregate in which unit modules are stacked according to an embodiment of the present invention.

Referring to FIGS. 1 to 3, a supercapacitor according to an embodiment of the present invention includes: a power storage aggregate 200 in which a plurality of unit modules 100 are laminated; a case 300 in which the power storage aggregate 200 is disposed and whose upper and lower portions are opened; an upper plate 310 that is sealably mounted on an upper surface of the case 300; and a lower plate 320 that is sealably mounted on a lower surface of the case 300.

The case 300 is formed into a rectangular box shape with the opened upper and lower portions and has a plurality of first fastening holes 302 formed in the vertical direction so as to be coupled with the upper plate 310 and the lower plate 320 via bolts.

The upper plate 310 includes: a cover portion 312 that is formed of a rectangular plate and is covered on the top surface of the case 300; and a projection portion 314 that is integrally formed on the lower surface of the cover portion 312 and inserted into the inner surface of the case 300. In addition, a plurality of second fastening holes 316 are formed in the circumferential direction of the cover portion 312.

The second fastening holes 316 formed in the upper plate 310 communicate with the first fastening holes 302 formed in the case 300, and the upper plate 310 and the case 300 are fastened by bolts 400 passing through the second fastening holes 316 and the first fastening holes 302.

In addition, a gasket 410 is provided on the lower surface of the cover portion 312, that is, a surface that is in contact with the upper surface of the case 300, and serves to seal between the upper plate 310 and the case 300.

A projection portion 314 that inserted into the inner surface of the case 300 is integrally formed on the lower surface of the upper plate 310, to thus prevent the upper plate 310 from being bent even if the internal pressure of the case 300 increases. That is, a warp phenomenon of the upper plate 310 can be prevented.

The lower plate 320 includes: a cover portion 322 that is formed of a rectangular plate and is covered on the bottom surface of the case 300; and a projection portion 324 that is integrally formed on the top surface of the cover portion 322 and inserted into the inner surface of the case 300. In addition, a plurality of third fastening holes 326 are formed in the circumferential direction of the cover portion 322.

Here, the bolts 400 pass through the second fastening holes 316 of the upper plate 310, the second fastening holes 302 of the case 300, and the third fastening holes 326 of the lower plate 326 and couple the upper plate 310, the case 300, and the lower plate 320 together.

In addition, a gasket 420 is provided on the upper surface of the cover portion 322, that is, a surface that is in contact with the lower surface of the case 300, and serves to seal between the lower plate 320 and the case 300.

A projection portion 324 that inserted into the inner surface of the case 300 is integrally formed on the upper surface of the lower plate 320, to thus prevent the lower plate 320 from being bent even if the internal pressure of the case 300 increases. That is, a warp phenomenon of the lower plate 320 can be prevented.

Reinforcing plates 330 and 332 are respectively disposed in the inner surfaces of the upper plate 310 and the lower plate 320 and serve to enhance the strength. Here, the reinforcing plates 330 and 332 are formed in the form of a rectangular plate having a certain thickness and are respectively disposed on the upper and lower surfaces of the case 300, thereby reinforcing strength and preventing the upper plate 310 and the lower plate 320 from being deformed even if the internal pressure of the case 300 increases.

The reinforcing plates 330 and 332 are preferably formed of a PET (polyethylene terephthalate) material.

A positive electrode plate 340 and a negative electrode plate 342 that are electrically connected to the power storage aggregate 200 are disposed in the inner surfaces of the reinforcing plates 330 and 332, respectively. Here, the positive electrode plate 340 may be used as the negative electrode plate, and the negative electrode plate 342 may be used as the positive electrode plate.

As shown in FIG. 3, the power storage aggregate 200 is formed by laminating a plurality of unit modules 100. The unit modules 100 may be one of a cathode and an anode, respectively, and have a structure of alternately stacking the cathode and the anode.

Each unit module 100 includes: a current collector 10; a first active material layer 20 that is laminated on one surface of the current collector 10; a second active material layer 30 that is laminated on the other surface of the current collector 10; a first separator 40 that is laminated on one surface of the first active material layer 20; and a second separator 50 that is laminated on one surface of the second active material layer 30.

In addition, as shown in FIG. 2, each of the unit modules 100 may have a structure that the collector 10, the first active material layer 20, the first separator 40, the second separator 50, the second active material layer 30, and the current collector 10 are sequentially stacked.

The current collector 10 may be formed of an aluminum foil or a copper foil. Further, the current collector 10 may be formed in a mesh shape having a large number of throughholes in order to perform migration of ions efficiently, and perform a uniform doping process.

One of the first active material layer 20 and the second active material layer 30 is the negative active material layer, and the remaining one is the positive electrode active material layer, and may include active carbon and a binder capable of reversibly doping and dedoping ions and can include a conductive material such as a carbon black and a solvent.

Natural pulp-group non-woven fabric or paper, and the like may be applied as the first separator 40 and the second separator 50. Besides, the first separator 40 and the second separator 50 may be formed of nanofibers in a nano-web form having a number of pores in which a polymeric substance is electrospun by an electrospinning method thereby creating and accumulating the nanofibers.

Here, the collector 10, the first and second active material layers 20 and 30, and the first and second separators 40 and 50 are formed differently from each other in size. In other words, in the case of the first active material layer 20 and the second active material layer 30, the optimal thickness and size are determined in a design process in accordance with an intended use. The first separator 40 and the second separator 50 are formed to have a larger size in comparison with the first active material layer 20 and the second active material layer 30, so as to seal the first active material layer 20 and the second active material layer 30 by covering the first active material layer 20 and the second active material layer 30, respectively, and wrapping the lateral sides of the first active material layer 20 and the second active material layer 30, respectively. The current collector 10 has a larger size in comparison with the first separator 40 and the second separator 50, in a manner that a plurality of unit modules 100 that are laminated in a subsequent process may be fixed to the case and connected with external terminals.

When the unit modules are laminated, ring-shaped reinforcement members 360 are provided between the current collectors 10, to thus prevent a variation in thickness from occurring according to the position of the lamination.

That is, since several tens of unit modules are laminated to form the unit modules 100, the unit modules that are laminated downside become small in thickness due to a great action of a rolling force and the unit modules that are laminated upside maintain the original thickness due to a small action of a rolling force. As a result, the unit modules differ from each other in thickness for positions of lamination, to thus lower charge-discharge performance.

To relieve these problems, in this embodiment, the reinforcing members 360 are provided between the current collectors 10. In addition, the upper surface of the reinforcing member 360 is in contact with the lower surface of the current collector 10 that is positioned above and the lower surface of the reinforcement member 360 is in contact with the upper surface of the current collector 10 that is positioned below, to thus prevent the unit modules from varying in thickness for positions of lamination.

The reinforcing members 360 are formed of a PET material and are formed into a ring shape, in which an outer surface of each of the reinforcing members 360 is in contact with the inner wall surface of the case 300, and upper and lower surfaces thereof is in contact with of the current collector 10, to thus play a role of supporting the respective unit modules. Then, when the unit modules are stacked, the reinforcing members 360 maintain position of alignment of the unit modules 100, to thus prevent the position of alignment of the unit modules 100 from varying during lamination of the unit modules 100.

As described above, the supercapacitor according to one embodiment of the present invention enables the unit modules 100 to be laminated in the inside of the case 300, to thus prevent an electrolyte from leaking.

In addition, projecting portions 314 and 324 that are inserted into the inside of the case 300 are formed on the upper plate 310 and the lower plate 320, and reinforcing plates 330 and 332 are disposed on the inner surfaces of the upper plate 310 and the lower plate 320 to reinforce the strength of the upper plate 310 and the lower plate 320, to thereby prevent the upper plate 310 and the lower plate 320 from being bent due to the pressure and to prevent the leakage of the electrolyte.

Also, the reinforcing members 360 are mounted between the current collectors 10 of the unit modules, to thus prevent a variation of thickness of the unit modules for positions of lamination.

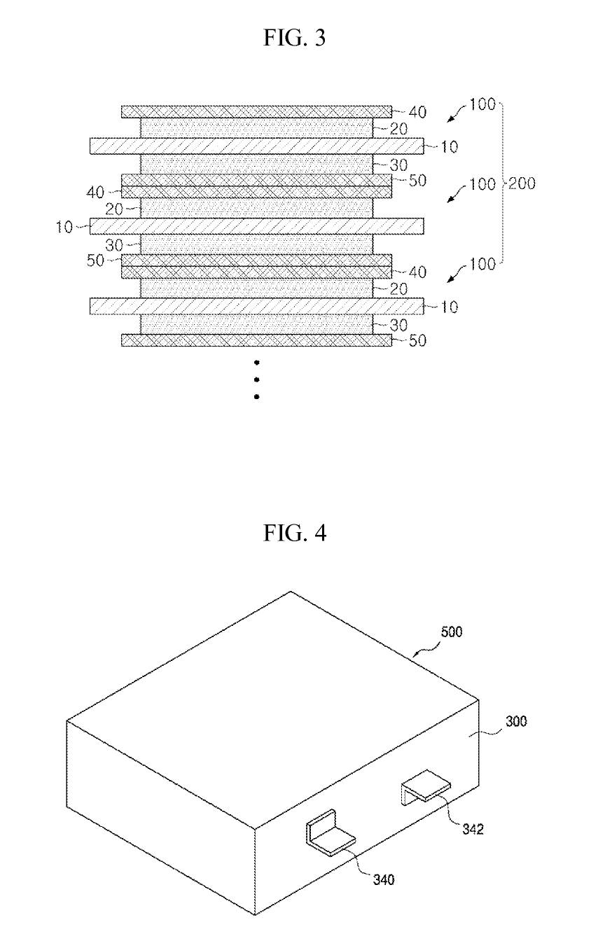

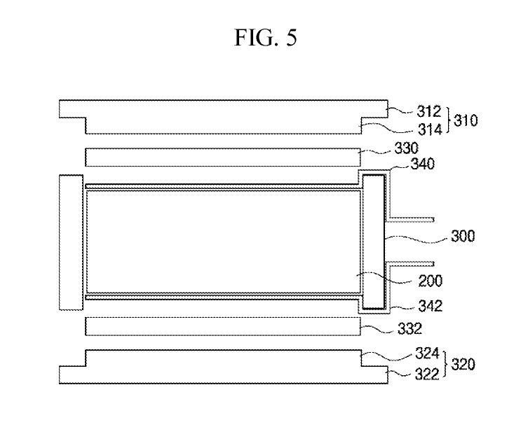

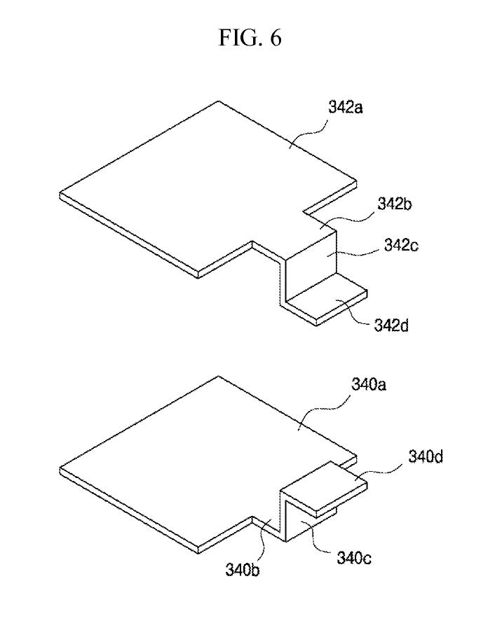

FIG. 4 is a perspective view for explaining a supercapacitor having outwardly projecting electrode plates according to one embodiment of the present invention. FIG. 5 is an exploded side view of a supercapacitor having outwardly projecting electrode plates according to one embodiment of the present invention. FIG. 6 is a perspective view for explaining the shape of the electrode plates of FIG. 5.

As shown in FIG. 4, in the present invention, the positive and negative electrode plates 340 and 342 are extended, and extension portions (340a and 342a of FIG. 6) that are respectively extended from the positive and negative electrode plates 340 and 342 are protruded to the outside of the case 300 of the supercapacitor 500 to thus implement terminals.

In more detail, as shown in FIG. 5, the outwardly protruded extension portions that are extended from the positive and negative electrode plates 340 and 342 and that are located between each of the reinforcing plates 330 and 332 and the power storage aggregate 200, are bent in a multi-stage form to then be protruded outwardly to thus prepare terminals.

That is, referring to FIG. 6, the extension portions 340b, 340c, and 340d extended from the extension portion 340a extended from the positive electrode plate 340 embedded in the case 300, and the extension portions 342b, 342c, and 342d extended from extension portion 342a extended from the positive electrode plate 342 embedded in the case 300, are bent in a two-stage form.

In addition, the extension portions 340b, 340c, and 340d extended from the extension portion 340a extended from the positive electrode plate 340, and the extension portions 342b, 342c, and 342d extended from the extension portion 342a extended from the positive electrode plate 342, are spaced apart from each other so as to prevent an electrical short.

Here, although not shown in FIG. 5, grooves that can accommodate the extension portions 340a and 342a extended from the positive and negative electrode plates 340 and 342 may exist in the case 300 or the upper and lower plates 310 and 320, and gaskets (not shown) may be provided between each of the upper and lower plates 310 and 320 and the case 300 to perform a sealing function, by considering the extension portions extended from the positive and negative electrode plates 340 and 342.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

1. A supercapacitor comprising:
a power storage aggregate in which a plurality of unit modules are laminated;
a case in which the power storage aggregate is disposed;
an upper plate that is sealably mounted on an upper surface of the case;
a lower plate that is sealably mounted on a lower surface of the case; and
reinforcing plates that are disposed in the inner surfaces of the upper plate and the lower plate thereby reinforcing strength of the upper and lower plates.

2. The supercapacitor according to claim 1, wherein the reinforcement plates comprise PET (polyethylene terephthalate) films.

3. The supercapacitor according to claim 1, wherein each of the upper plate and the lower plate comprises:
a cover portion that is covered on the respective top and bottom surfaces of the case; and
a projection portion that is integrally formed on the cover portion and inserted into the inner surface of the case.

4. The supercapacitor according to claim 1, wherein a plurality of first fastening holes are formed in the circumferential direction of the case,
a plurality of second fastening holes are formed in the circumferential direction of the upper plate,
a plurality of third fastening holes are formed in the circumferential direction of the lower plate, and
corresponding holes of the first, second and third fastening holes are fastened by a single bolt.

5. The supercapacitor according to claim 1, wherein each unit module comprises:
a current collector;
a first active material layer that is laminated on one surface of the current collector;
a second active material layer that is laminated on the other surface of the current collector;
a first separator that is laminated on one surface of the first active material layer; and
a second separator that is laminated on one surface of the second active material layer.

6. The supercapacitor according to claim 5, wherein the plurality of the unit modules are laminated to form the power storage aggregate, and wherein reinforcing members are mounted between the current collectors of the unit modules.

7. The supercapacitor according to claim 6, wherein the reinforcing members are formed into a ring shape in which the outer surface of each of the reinforcing members contacts the inner wall surface of the case, and the upper and lower surfaces of each of the reinforcing members are supported by the current collectors.

8. The supercapacitor according to claim 6, wherein the reinforcing members are formed of a PET (polyethylene terephthalate) material.

9. The supercapacitor according to claim 1, wherein the reinforcement plates are disposed between each of the upper plate and lower plate and the power storage aggregate, respectively,
positive and negative electrode plates are interposed between each of the reinforcement plates and the power storage aggregate, respectively, and
extension portions that are extended from the positive and negative electrode plates to then be protruded to outside the case, and to thus be implemented as a terminal.

10. The supercapacitor according to claim 9, wherein the extension portions that are extended from the positive and negative electrode plates are bent in a multi-stage from.

11. The supercapacitor according to claim 9, wherein the extension portions that are extended from the positive and negative electrode plates are spaced from each other.
